(19) United States
(12) Patent Application Publication
(10) Pub. No.: US 2009/0104874 A1
(43) Pub. Date: Apr. 23, 2009

(54) System And Method Of Providing Automatic Information Exchange And Matching

(76) Inventor: John Ellis, Austin, TX (US)

Correspondence Address: DLA PIPER LLP (US ), 2000 UNIVERSITY AVENUE, EAST PALO ALTO, CA, 94303-2248, US

(21) Appl. No.: 12/270,641

(22) Filed: Nov. 13, 2008

Related U.S. Application Data
(62) Division of application No. 10/170,807, filed on Jun. 13, 2002.
(60) Provisional application No. 60/298,187, filed on Jun. 13, 2001.

(51) Int. Cl. H04B 7/26; H04B 7/24

(52) U.S. Cl. 455/41.2; 455/39

(57) ABSTRACT

A method and apparatus provides wireless transceivers which may be used for various tasks, including the exchange of information with other devices. In one example, the wireless transceivers are a part of a WIC used in an environment such as an amusement park, water park, reception area, or tradeshow to provide various capabilities.

### CROSS REFERENCE TO RELATED APPLICATIONS

This application is a divisional of U.S. application Ser. No. 10/170,807, filed Jun. 13, 2002, which claims the benefit of U.S. Provisional Application No. 60/298,187, filed on Jun. 13, 2001, which are both incorporated by reference herein.

### FIELD OF THE INVENTION

This invention relates to wireless devices. In particular, this invention is drawn to wireless transceivers which may be used for various tasks, including the exchange of information with other devices.

### BACKGROUND OF THE INVENTION

The computer and telecommunication revolution has provided an enormous amount of information that is presented in various forms and in very large quantities. Sorting through this information has become an arduous task, even when computing systems are available for data mining and analysis. When it comes to screening out information that is valuable to a human, device, or system—in order to be able to make timely, expert decisions—little has been done to ease the burden of this analysis and decision making in daily life. Our laptops, personal digital assistants, and even our phone systems, while being of high utility and value, force the user to sort through a large amount of extraneous information. Likewise, in the relationships between humans, this amount of extraneous information which must be gathered and sorted in a focused, time-sensitive environment, while interesting, can make the determination of valued information on which decisions need to be made difficult to evaluate as can be masked or obscured.

Even when problems such as those addressed above are solved, there are various problems in the prior art that have not been solved using advances in computers and telecommunications. For example, in various environments where people are out of communication with each other, communication is desired. In addition, the exchange of tangible items or information has inherent problems. For example, in an environment such as an amusement park (or a water park, etc.), several problems are apparent. First, people are concerned about knowing where their friends or family are located. Second, it is cumbersome and inconvenient to carry a wallet or purse while visiting such an environment. There are also problems that the operators of such an environment encounter. For example, it can be difficult for the operators to track where patrons spend their time or spend their money, and to account for money spent by patrons. As another example, in an environment such as a networking business reception or a trade-show, sorting through numerous attendees' business capabilities as compared to one's business interests is very difficult within an hour or two of verbal dialogue with numerous guests at the social or trade event. An automatic means to prescreen interests and provide a discreet notification of matching needs and wants would be very valuable.

### SUMMARY OF THE INVENTION

A method for facilitating the exchange of information between wireless devices, which includes providing a plurality of wireless devices, each having a transceiver, a processor, and memory, storing information in each of the memories of the wireless devices relating to characteristics of an actor associated with that wireless device, automatically establishing a wireless link between a first and a second of the wireless devices, sending the information stored in the first wireless device to the second wireless device via the wireless link, and generating a notification at the second wireless device if the sent information meets a predetermined criteria.

A system for facilitating the exchange of information between wireless devices, which includes a plurality of wireless devices. Each of the wireless devices has a transceiver, a processor, a memory for storing information relating to characteristics of an actor associated with that wireless device, and a notification device. For each of the wireless devices, the processor and transceiver are configured to automatically establish a wireless link with another of the plurality of wireless devices, receive the stored information from the another of the plurality of wireless devices via the wireless link, and automatically trigger the notification device if the received information meets a predetermined criteria.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a view of the Wireless Intelligent Communicator (WIC) system.

FIG. 2 is a block diagram of the (WIC) device shown in FIG. 1.

FIG. 3 is a block diagram of the WIC programming device shown in FIG. 1.

FIG. 4 is a block diagram of the WIC data logger and analysis device shown in FIG. 1.

FIG. 5 is a diagram of a map used for tracing WICs.

FIG. 6 is a diagram of the map shown in FIG. 5 showing the WICs.

FIG. 7 is a diagram showing the location of a WIC, relative to two transceivers.

FIGS. 8 and 9 are views of two types of WICs of the present invention.

FIGS. 10 and 11 are block diagrams of WICs of the present invention.

### DETAILED DESCRIPTION

In general, the present invention is capable of providing wireless devices that solve many problems in the prior art. For example, the present invention can solve the problems described above relating to an amusement park environment or a reception or trade-show environment using wireless devices (described below). The present invention may also be used in any other type of service area. Also described below is one example of system which may be used to implement various applications of the present invention, including the described applications relating to amusement parks and trade-shows. Note, however, that the present invention may be used for limitless other applications. Also note that the wireless intelligent communicator system described below is merely one example and that the invention may also be implemented using other systems.

The device and system described below is meant to provide an automated and interactive means to perform detailed, intelligent matching of common notification characteristics to specified criteria and provides follow-on information exchange between actors based on the results, if desired. Furthermore, the initial exchange of information and matching is performed wirelessly and automatically, further lightening the load for the actors by relieving them of the burden of connecting cables or performing time-consuming setup or decision making. The actor participates in the information exchange process when the “behind-the-scenes” work is completed and the need for attention is warranted. Furthermore, detailed information about interactions made during the course of the day can be logged into the device and a record and analysis of the activities (not previously notified, unless warranted) can be displayed or printed.

In the following description, the actors can be human, machine, or smart sensors. When referring to a specific actor type, it will be explicitly specified. Otherwise, the term actor is generically applied to all actor types.

The Wireless Intelligent Communicator (WIC) device and system can be for information exchange between actors as well as follow-on characteristics matching to actor criteria. In one example, an actor would program the WIC device with a list of characteristics (physical, mental, lifestyle, interests, business interest, equipment capabilities, roles, available goods and services credits, etc.), which can be exact, fuzzy or descriptive values. Additionally, match criteria are programmed, wherein each characteristic of interest is accompanied by an indicator of whether this characteristic is desirable or undesirable. The relative importance of the each criterion is also entered and stored. When the WIC device is used in an environment where one or more other WIC devices is in operation, the WIC device will automatically establish a wireless link with the other WIC device and in a predetermined manner and protocol, request characteristics from the other WIC device. The link may be either secure or unsecure, based on the underlying protocol and environment. When the characteristics have been acquired, the match algorithm on the WIC device analyzes for a match to the criteria. The type of match algorithm used is not important to the invention. Therefore, any desired match algorithm may be used with the invention. For example, a device solely intended for the exchange of monetary, or goods and services credits may use a simple Boolean logic decision tree rather than a fuzzy-value based algorithm—or a combination of algorithms may exist for multiple uses within an environment. If a match is found, the actor is notified via physical or audible means, in the case of a human actor, or digital I/O, in the case of a machine actor. The actor is then given the choice of sending additional information, such as further description, photo, or goods and services credits, or ignoring the match-based notification. At this point, the actor can decide also to just log the data for future reference or proceed to exchange further information. For human actors, input to the WIC device is provided by a keypad, touch-screen, or audible input with voice recognition. For machine actors, input is via an analog and/or digital I/O interface. For human actors, a direct actor-to-actor audible link would also be available for secure dialogue.

Additionally, an option is provided for entering a “find-mode” wherein the WIC device provides audible or sensory or analog/digital input to the actor to allow the actor to direct their search in the proper direction based on the wireless strength of signal and signal direction from the other WIC device.

The WIC device can be programmed through a conventional personal computer equipped with a wireless transceiver or serial cable (RS232, USB, etc.). Likewise, for those human actors not capable of programming by this means, a WIC programming device that may accept payment via cash or credit/debit card, would be provided at select locations in the environment of use. If the WIC device is used in a closed environment, the programming of the device would also allow for a environment code to ensure use of that device is constrained to the environment and to a predetermined set of match criteria categories. The WIC device can be programmed to hold all characteristics related to the environment of use, including, but not limited to characteristics such as match criteria, actor characteristics, photos of the actor or actor's environment, and monetary and goods and services credits. If the actor is a machine or smart sensor, the interface to the WIC device allows the machine or sensor to program the characteristics directly.

There will be instances of use where the actor would like to record and analyze the interactions of the day, including those that may or may not have progressed to the level of requiring notification. In this case, WIC device, if selected to do so, will record these interactions in non-volatile memory. These interactions can be downloaded to a compatible personal computer if desired. Additionally, this data can be made available for download, analysis, audit, and printout to a WIC logging and analysis device. Depending on the sensitivity of the information, it may or may not be made available for logging.

There will be instances of use where the WIC device, WIC programming device, or WIC logging and analysis device may have access to a local area network. In this case, information from the device may be sent, if desired, into the local area network to allow networking to take place over a longer range than the immediate vicinity in which the WIC device, programming device, or logging and analysis device is operating. Information may then be logged to a central server, if desired.

An environment where characteristic matching is a high priority, but the ability to do so is constrained by resources—i.e. limited by time or space, the WIC device can be used to facilitate interaction with those most likely to provide value. In such a setting, one-to-one human-to-human actor, human to machine or sensor actor matching could be performed, along with the ensuing information exchange if a desired match was found. These environments could include, but are not limited to: trade shows, symposiums, conferences, conventions, churches, schools, museums, parks, resorts, bars, concerts, fairs, athletics events, etc.

For example, in a networking reception prior to a key symposium, dialogue between many attendees takes place, with exchange of business cards, and other pertinent information. However, what quite often happens is that attendees migrate to talk with other attendees that they already have established relationships with due to the natural inclination to go to what is familiar. Many potential business contacts are lost due to the discomfort of introducing oneself to an unknown attendee who may or may not have anything in common or possess those characteristics that would provide them with value. On the other hand, the attendee may also provide the key asset to future business success. The WIC device would alert the human actor to potential key contacts, and give the option of arranging a meeting or delaying the meeting until later in the event. Additionally, credits for drinks, food, or other goods and services may be stored in the WIC and the credits deducted throughout the event as used via a WIC programming device at the event concession area.

Another example is a trade show floor, where the WIC device would provide value for attendees and exhibitors alike. A large trade show, with thousands of potential customers and as many exhibitors, creates an environment where each minute spent in unproductive conversation with an unlikely candidate for your business means opportunity cost for when you could have talked with a ready buyer. As the real purpose of trade show is to provide a venue to facilitate business, automatic prescreening of contacts based on characteristics is of tremendous value. In this case, not only could a vendor and buyer be equipped with the WIC device, but the wireless Text-To-Speech could be used to provide direct, audible notification of characteristics, via an unobtrusive ear piece. This also prevents disruption of the current conversation or activities such as would happen if the human actor was required to quickly answer a page and/or read a display before the potential contact has left the area. Additionally, if the environment allows, goods and services credits can be stored on the WIC device allowing direct purchase on the show floor. Finally, if, based on the match results and actor-defined rules, information is desired without the human interaction, the WIC-enabled logger at each booth would provide the match data to the vendor for later dissemination of product information via other means.

More and more factories are moving to an environment where wireless communication is replacing and augmenting the factory network. In this case, and even where wireless networks do not currently exist, wireless-enabled equipment and sensors are becoming commonplace. The difficulty with this environment comes from the fact that there may be a plethora of such devices that are in various states of use and condition and must be monitored. To quickly determine the state of the device is difficult, as each device can provides a wealth of data that must be sorted through. Additionally, such devices can be buried inside a larger piece of equipment that prevents the device from direct communication with the existing LAN, though, through their intelligence, the device may possess a great deal of information about its own status. In such a case, where a device needs attention for whatever reason, and another actor (human or machine) might have the information required to meet the need, a need exists for an ad-hoc wireless link be made to an actor to see if they have the information or can provide the authorized service required. The WIC device enables such interactions to automatically take place, with notification occurring on a needs-based match of characteristics and criteria. Such requests from a machine actor, enabled with the WIC device, might be for maintenance, troubleshooting, reboot, or any other such variety.

There are some situations where a human actor in this environment is not able to readily access a manual input to the WIC device or equipment or sensor. Examples are a clean room environment in a semiconductor fab and in a petroleum refinery in a maintenance environment. In such cases, the ability to pass text information that would be translated into voice at the human actor's WIC device allows the human actor to be made aware of the need without resorting to opening a personal data assistant, laptop, or other such device. Voice commands from the human actor, translated into machine interpretable data via voice recognition on the WIC device, would provide input to the WIC device-enabled equipment without the need for interaction via keypad and display. Likewise, if the need requires more detailed information and dialogue to take place between the equipment and the user, the keypad/touch-screen and display on the WIC device, if the environment allows, could be used. Information, such as equipment location, type, model, photos, and other would be stored on the WIC device and passed to the human actor's WIC device via the wireless link as required. Any other internal variables deemed necessary, and authorized based on the actor's match criteria (which would include role and responsibility) would be available for display and/or translation to speech.

The capability could exist for maintenance or other authorized roles within the environment to give and receive goods and services credits for services rendered via the WIC device. For example, a smart sensor that has detected failure is imminent and has alerted the local, outsourced maintenance person, who is on a piecework contract, would, upon WIC device match, notification, and detection of services rendered, apply credits to the personnel's WIC device.

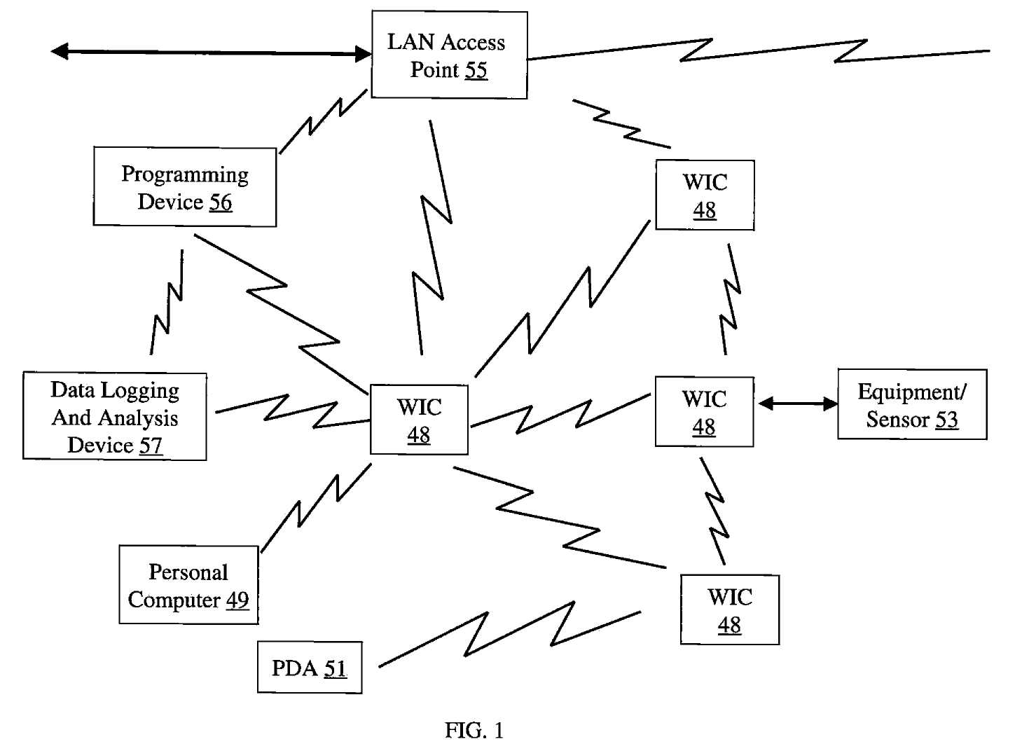

With reference to FIG. 1, in one example, the Wireless Intelligent Communicator (WIC) system consists of two or more WICs 48 (each associated with an actor), which communicate via ad-hoc, wireless (Radio Frequency or Optical) links. The conventional use and operation of wireless transceivers, such as Bluetooth or other such as specified by the IEEE standard 802.11, are well known to those skilled in the art. Note that, while FIG. 1 shows four WICs 48, as few, or as many WICs 48 as desired could be used. Additionally, to enable programming of the devices, one or more programming devices 56 may be used in the system. To enable data logging and analysis, one or more data logging and analysis devices 57 may also be included. Finally, a LAN access point 55 that contains a transceiver capable of talking with any of the aforementioned devices may be present, though not required.

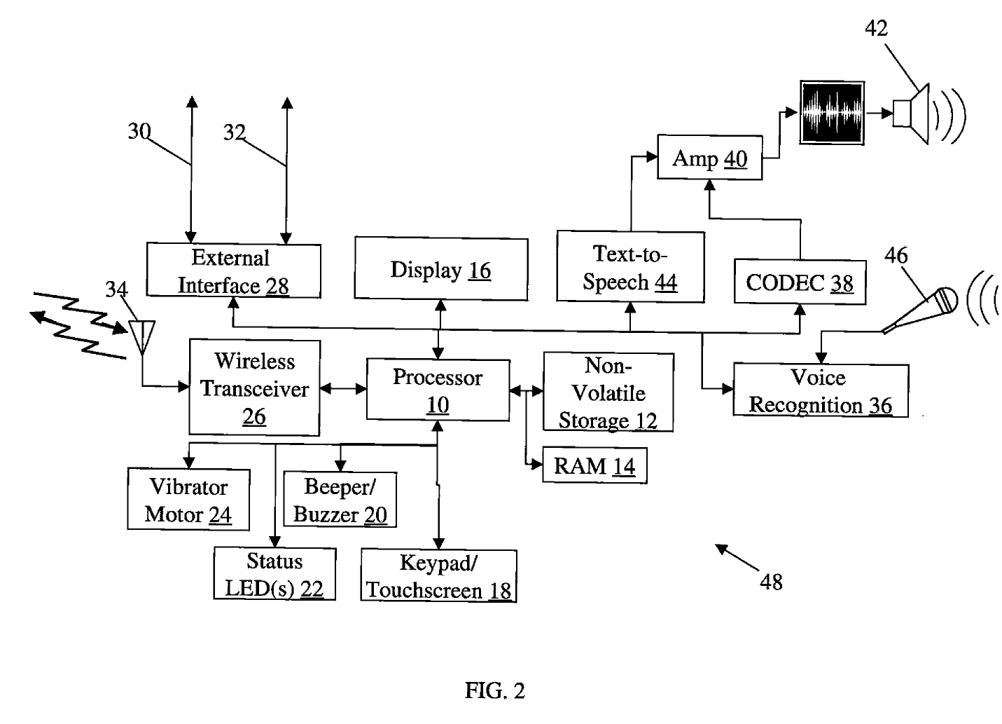

With reference to FIG. 2, one example of the WIC 48 consists of an embedded processor 10, connected to nonvolatile storage 12, random access memory 14, a wireless transceiver 26 and antenna 34, and one or more notification components: vibrator motor 24, beeper/buzzer 20 or status LED's 22. Additionally, the WIC 48 may contain one or more of the following components: keypad/touchscreen 18, display 16, Text-To-Speech processor 44, voice recognition processor 36, audio encoding decoding unit (CODEC) 38, audio amplifier 40, earpiece or speaker 42, and microphone 46. An external interface 28 is provided to allow for analog input and output 30 and digital input and output 32.

When two or more WIC devices 48 come into proximity of one another, an ad-hoc, wireless, peer-to-peer connection is established through use of the underlying wireless protocol. At this point, in one example, the WIC devices 48 exchange actor characteristics and the match algorithm is applied to the characteristics and actor criteria to determine the level of match. If the match level exceeds that which the actor has specified as acceptable, the WIC 48 notifies the actor. In the case of a human actor, the notification can occur through one or more annunciation components: vibrator motor 24, beeper/buzzer 20, status LEDs 22, display 16, or Text-To-Speech 44. A machine actor will be notified through use of the digital I/O 32 on the external interface 28. Upon reception of notification, the human actor can, via the keypad/touch-screen 18 or microphone 46 and voice recognition processor 36, choose to continue the interaction through selection of further information and characteristics to exchange, enter direct voice communication via the microphone 46 and CODEC 38 which digitizes the voice for transmission over the wireless transceiver 26. Alternatively, or in addition, if the actor requesting information is not visible or known, the other actor may be found by entering the “find or avoid” mode of the device. A machine actor performs its input via the digital I/O 32 and analog I/O 30 on the external interface 28. A record of each peer-to-peer connection and log history of interaction may be stored in non-volatile storage 12 if the actor desires.

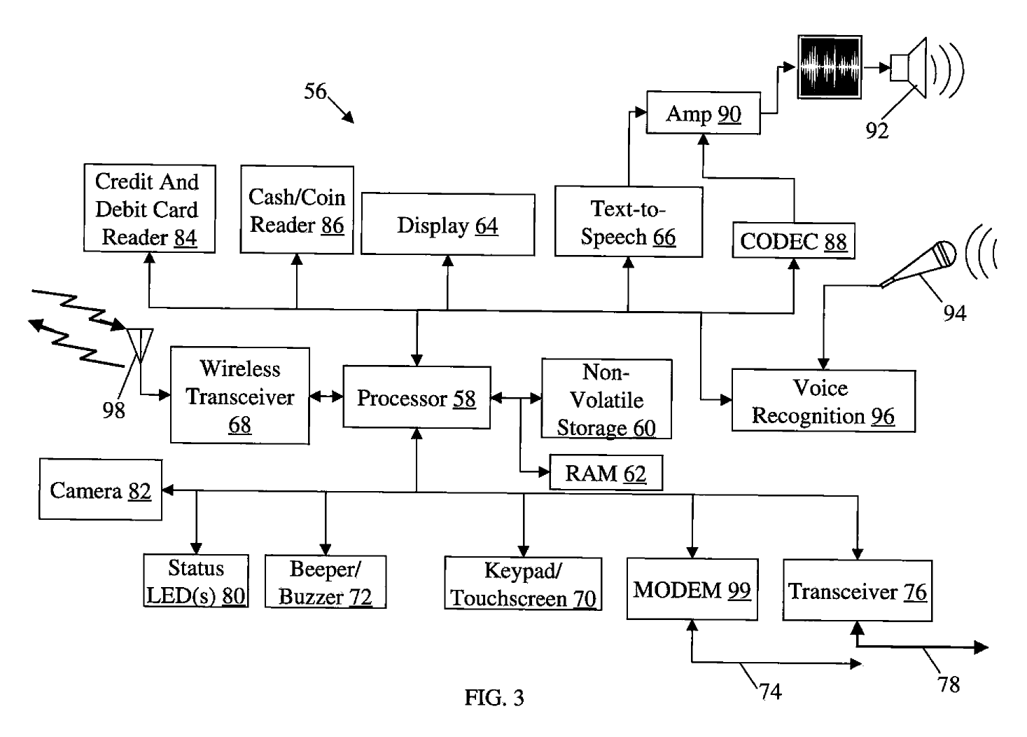

With reference to FIG. 3, one example of the WIC programming device 56 consists of a processor 58, connected to nonvolatile storage 60, random access memory 62, a wireless transceiver 68 and antenna 98, keypad or touch-screen 70 and a display 64. Additionally, the WIC programming device 56 may contain one or more of the following components: a cash/coin reader 86, credit and debit card reader 84, Text-To-Speech processor 66, voice recognition processor 96, audio encoding decoding unit (CODEC) 88, audio amplifier 90, earpiece or speaker 92, microphone 94, digital camera 82, status LEDs 80, beeper/buzzer 72, MODEM 99 connection to a phone or ISDN line 74 or transceiver 76 connection to a LAN 78.

The WIC device 48 may be programmed through a variety of means. A personal computer 49, PDA 51, or similar device equipped with programming software and containing a compatible wireless transceiver or wire-based connection to the Wireless Intelligent Communicator device 48 is one option for programming. In a constrained or captive environment or the case where the human actor cannot access or afford the previously mentioned programming devices, a WIC Programming device 56 can be made available for use.

Though programming of the WIC 48 can done on a fee basis through the use of the cash/coin reader 86 and/or credit and debit card reader 84, no fee may be necessary depending on the ownership and application of the WIC programming device 56. In all cases, programming a WIC device 48 consists of gathering salient information such as role information, likes and dislikes, and needs and wants of the actor, typically via the answering of a questionnaire. The questionnaire may be tailored to the particular application. Other data that may be gathered includes digital photographs of the actor through use of the digital camera 82. If the cash/coin reader 86 or credit and debit card reader 84 are available, goods and services credits may be collected as actor characteristics. Once the characteristics are known, they are transmitted to the Wireless Intelligent Communicator device 48 for storage in non-volatile storage 12. Likewise, through a similar process, the match criteria are input into the WIC Programming device 56, transmitted to and stored in the WIC device 48.

In the case where the WIC device 48 is connected to a piece of equipment or sensor 53 (FIG. 1), which is providing data to the WIC device 48, the characteristic data may be dynamically changed due to a change in state or condition of the equipment or sensor 53. The connection between a WIC 48 and a piece of equipment or sensor 53 may take the form of an analog and/or digital I/O. The match criteria may also be dynamically changed based on the state and level of severity of the need for attention to the condition of the equipment or sensor 53. In this case, a WIC programming device 56 will not be required for the WIC device 48-enabled equipment or sensor 53. Characteristics, such as photos and diagrams, still apply and will be stored in the WIC device 48 attached to the equipment or sensor 53. Similarly, goods and services credits for automatic payment for maintenance, services rendered, and reception of valued information would be created by and/or stored in the WIC device 48.

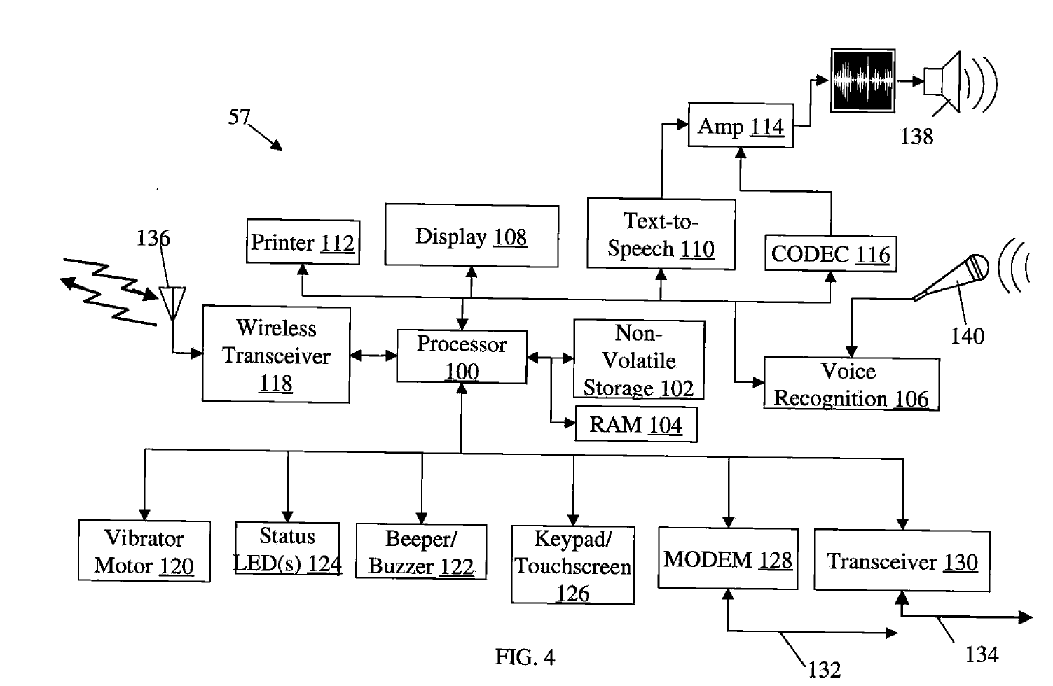

With reference to FIG. 4, one example of the WIC data logger and analysis device 57 consists of a processor 100, connected to nonvolatile storage 102, random access memory 104, a wireless transceiver 118 and antenna 136, keypad or touch-screen 126 and a display 108. Additionally, the Wireless Intelligent Communicator Data Logger and Analysis device 57 may contain one or more of the following components: Text-To-Speech processor 110, voice recognition processor 106, audio encoding decoding unit (CODEC) 116, audio amplifier 114, earpiece or speaker 138, microphone 140, status LEDs 124, beeper/buzzer 122, printer 112, MODEM 128 connection to a phone or ISDN line 132 and transceiver 130 connection to a LAN 134.

The WIC data logger and analysis device 57 is used to gather characteristics from many WIC devices 48 in rapid succession. As the WIC data logger and analysis device 57 may be equipped with printing capability, a permanent record of transactions to and from each WIC device 48 may be made readily available without the need to download information to a personal computer 49 or PDA 51 (FIG. 1). More in-depth analysis including actor demographics, equipment or sensor 53 mean-time-to-failure and repair, uptime, downtime, and utilization may be performed on the WIC data logger and analysis device 57. Visible notification of matches and in-depth analysis thereof can be provided through real-time updates on the display 108 as well as signaling of high-priority events or important trends via the annunciators: vibrator motor 120, beeper/buzzer 122, Text-To-Speech 110, or status LEDs 124. Notification of the analysis trends signaling a high-priority event can also be communicated to other WIC devices 48 detected within range if the match characteristics allow such transmission to occur. Finally, notification and trends can be reported, via the MODEM 128 or LAN 134, to another system or server for logging or further action.

The “find or avoid” mode of the WIC device 48 allows an actor to find another WIC device 48. When the match criteria are met by the characteristics transmitted, and the actors have both agreed to find each other, the WIC device 48 will make known the proximity of the other actor via measurement and annunciation of the strength and/or direction of the wireless signal, as compared to the known signal strength model. The annunciation may consist of change in the frequency, repetition, or duration of tone or pulse from the beeper/buzzer 20, status LEDs 22, or vibrator motor 24. The frequency, repetition, or duration will increase or decrease based on the actors drawing nearer or farther from the other actor's WIC device 48. Annunciation may also be provided via the Text-To-Speech processor 44, in which case a verbal cue is provided through the earpiece or speaker 42.

In an analogous manner, there may be situations in which the actor desires to avoid another human or machine actor. When these avoidance criteria match the characteristics from another WIC device within range the WIC device 48 will have been programmed to issue a distinguishable warning frequency, repetition, or duration in tone or pulse, or verbal cue. This annunciation will likewise be modulated by strength of signal and direction in order to provide guidance away from the actor. In this case, no mutual agreement of entering this warning or avoidance mode is required in order to make the recognition and warning immediate. It also serves to not alert the undesired actor in case the actor is human.

In the case where the actor seeking to find or avoid another detected actor is a machine, the annunciation of proximity, through signal strength and signal direction, will be transmitted to the machine actor via the digital interface 32.

There are times in the environments previously described, as well as other environments where the invention can be used, that a general, digital or vector-based map of the area, such as a trade-show floor or park, is available. In this case, the access points, which would also be located on the displayed map, would allow the unit location to be determined to within two or more of the access points. In this way, a coarse location of a desired WIC could be found. The strength of signal of the WIC being tracked would also be an indicator of distance from the access points. A plausible scenario might be for a user to access a programming unit and enter a command to display the location of a WIC, whose unit code or name would be known by the user and system. The trace command would then be sent out through the wireless LAN to the access points which would have a list of the WIC devices within range. This information would be passed back to the access point or programming unit (kiosk) for either audible or visual map and/or WIC location display. The user trying to locate the WIC device would not be required to possess a device themselves if using a programming unit for locating. However, if the user is also equipped with a WIC, and the WIC has an adequate input and display, the user can perform the location function without the need for use of a programming unit. The command would go directly from that user's WIC to their local access point and proceed as previously described. The location would be displayed on the user's WIC display.

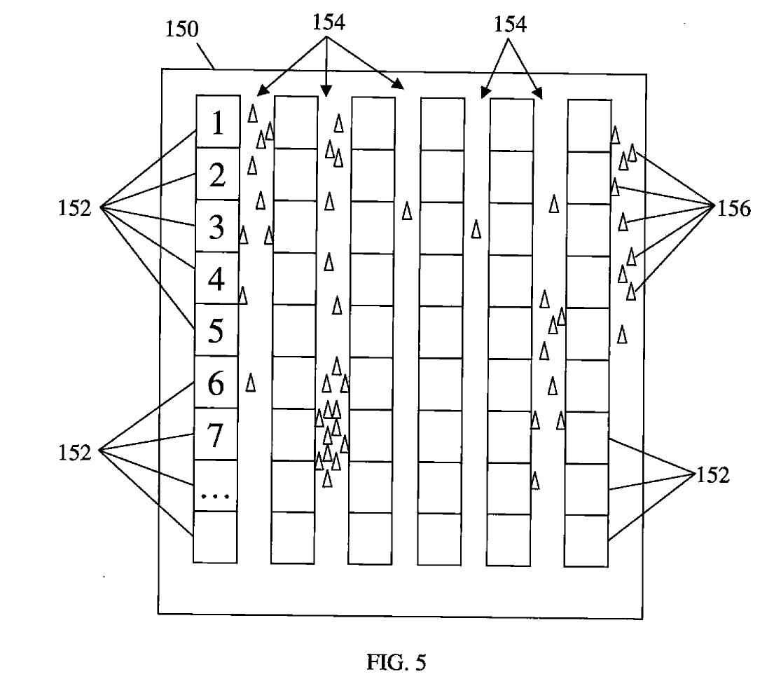

FIG. 5 shows the mapping/tracking function of the system. In this example, an electronic map 150 of an event (e.g., a trade show, etc.) floor is shown on a display contained in a programming unit or a capable WIC. The map illustrates rows of booths 152 with aisles 154 formed between adjacent rows. A plurality of WICs 156 being tracked are shown at various locations on the map 150. The present invention provides techniques for locating any WIC 156 within the map 150 based on communications between a WIC 156 and transceivers or access points (described below).

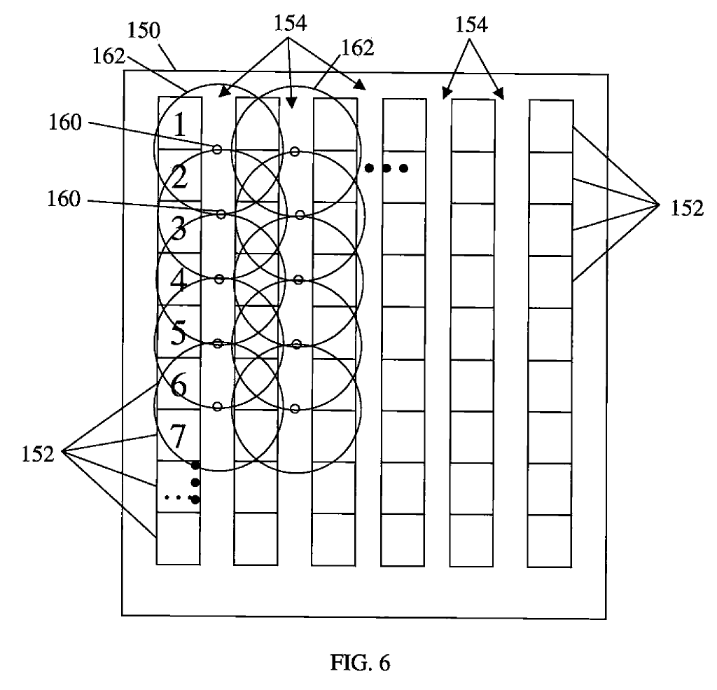

FIG. 6 illustrates a representative layout of the access points/transceivers on the map 150. FIG. 6 shows a plurality of transceivers 160 spread over the map 150. For clarity, FIG. 6 only shows 10 transceivers 160, although preferably, the transceivers 160 will provide coverage over the entire map 150. The transceivers 160 can be placed in any desired location. For example, in an outdoor setting, the transceivers 160 could be placed on light poles or other objects having a power source. In an indoor setting, the transceivers 160 could be placed on ceilings or on other objects. The approximate usable range of each transceiver 160 is illustrated in FIG. 6 with a circle 162. As shown, the ranges of the transceivers 160 in FIG. 6 overlap one another to provide an approximate 50% overlap in coverage. The range of the transceivers 160 will vary depending on the type of device used and other factors. For example if the transceivers 160 are Bluetooth transceivers, they may have a range of about 100 meters.

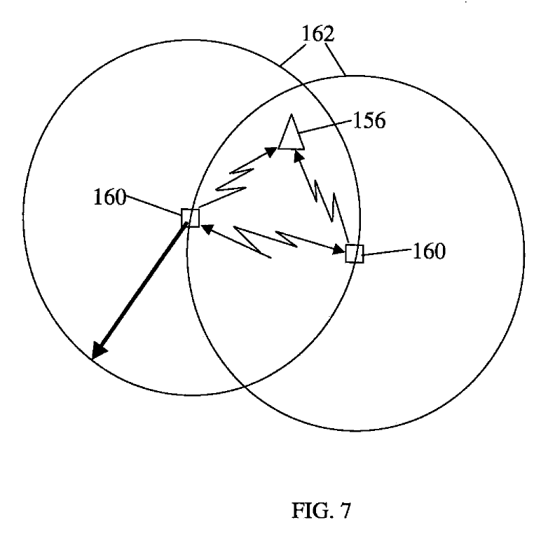

FIG. 7 is an enlarged view showing a WIC 156 located between two transceivers 160. If the WIC 156 is communicating with a certain transceiver 160, then the system knows that the WIC 156 is within the range 162 of that transceiver 160. When overlapping transceivers 160 both detect the WIC 156 (like in FIG. 7), the system knows that the WIC 156 is within the overlapping ranges 162 of the two transceivers 160. To get even more accurate location information, the approximate distance between the WIC 156 and the transceivers 160 can be determined by measuring the signal amplitude transmitted by the WIC 156 or received by the WIC 156. Using triangulation, the location of the WIC 156 can be narrowed down even more. A third transceiver 160 would allow the WIC to be fairly accurately located.

Likewise, in addition to locating a WIC and its user, it would be beneficial to send out a message to a WIC. In this case, a user could use any of the previously described means to not only locate a user, but send a text or voice message, or a page to the other WIC. Likewise, the other user can send a text or voice message, or a page, back to the originating WIC. If the WIC is not equipped with voice or display capability, the user may need to use a programming unit to retrieve a message or further interact with the requesting WIC.

One example of an application of the present invention is in environments such as amusement parks, water parks, etc. This present invention provides the capability of providing intelligent, wireless, active transceivers to patrons of the park. This device, hereinafter referred to as a Wireless Intelligent Communicator, or WIC, is differentiated from passive, short-range devices, such as RF-tags, by including an active transceiver with relatively long-range, two-way communication capability, and a processor for providing on-board intelligence for information exchange, commerce, tracking, characteristics matching simultaneously between multiple devices in an ad-hoc manner.

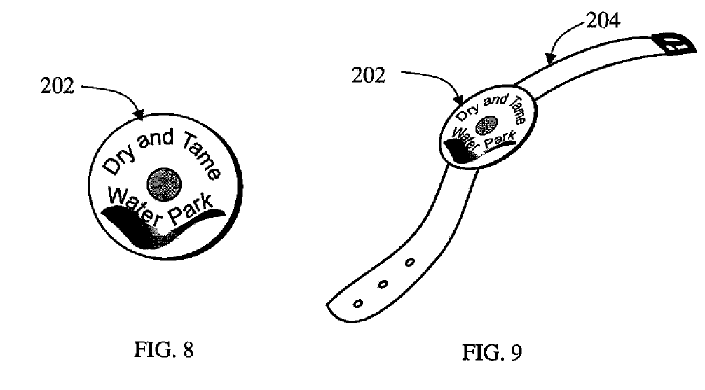

FIGS. 8 and 9 show two examples of WICs 202 which can be attached to clothing or worn with a wristband 204. Of course, a WIC 202 may take on many other forms as well. Preferably, the WICs 202 are waterproof. As is described below, the WICs 202 give patrons of the park the ability to put items in a locker that otherwise would have to be carried.

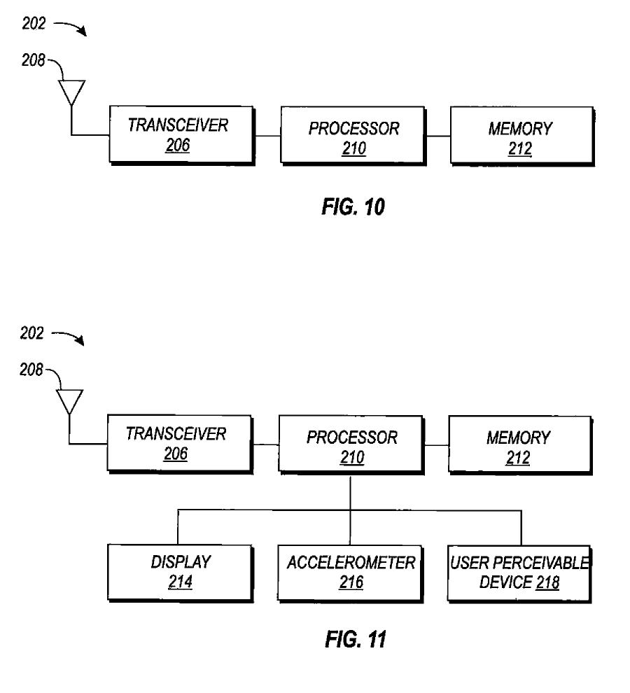

In one example, the WICs 202 are wireless, intelligent WICs enabled by wireless technology (e.g., Bluetooth, which is capable of high-speed encrypted data transmission). FIG. 10 is a block diagram of a WIC 202. The WIC 202 shown in FIG. 10 includes a transceiver 206, corresponding antenna 208, an embedded processor 210, and memory 212. The WIC 202 provides for wireless, secure personal transfer of finds between patrons and vendors instead of using cash or credit cards. As a result, the patrons can leave cash, credit cards, etc. in a locker or in their vehicle. The WICs 202 also provide a system for storing information and remotely locating or paging other member of a patron's party. In addition to the WICs 202, WIC-enabled kiosks may be provided to transfer money, or goods and service credits to/from the WIC or for locating and/or paging party members. The WICs 202 also provide the capability for making purchases at stores or restaurants, etc. The goods and services credits may be segmented according to the desire of the user of the WIC. For example, if a parent desires that their child only spend stored credits on food and drinks, the credits in the WIC may be identified as such and available for this use only.

In one example, park patrons may purchase or rent the use of a WIC upon arrival to the park. The WIC is then loaded with electronic cash, as well as a PIN number. If desired, a photo of the patron may also be loaded into memory of the WIC. While at the park, the patrons can then use the WICs, rather than cash, to make purchases. The amount of the purchases are deducted from the balance associated with the WIC. Patrons can use kiosks to add more electronic cash, locate party members, and/or to remotely transfer finds to other party members. Since the totality of the information required for transactions may be stored on the device, and the device provides its own intelligence via the on-board processor, there is no requirement for a network to a central server to exist for transactions to occur, though this is not precluded. The ad-hoc networking nature of the WIC devices allow connections to be made and broken as the users go in and out of range of other WIC devices, kiosks, programmers, and access points through the course of the visit.

There are several benefits to using the electronic cash associated with a WIC. First, patrons do not need to carry cash or credit cards. The WICs can be “recharged” at any time at any WIC-enabled kiosk (i.e. programming unit). Funds can be transferred wirelessly to other party members, even across the park (if wireless or wired-network equipped), as needed. At the end of the day, a patron can receive a refund of unspent electronic cash. In addition, if a network and server is provided, a secure record of transactions can be kept in case of loss or theft of a WIC. Finally, the WICs are very simple to use. In one example, a WIC has no buttons. In another example, a WIC can have a button for pager acknowledgment. Of course, as many buttons, displays, etc. as needed can be included.

With respect to security, the WICs can provide for secure, encrypted exchange of information. In addition, a photo ID can be stored in the WIC memory for display at a store. If desired, a PIN-entry can be required at a store to provide another level of security. Also, if a WIC is lost or stolen, it can be remotely disabled to prevent it from being used.

The WICs 202 also provide various capabilities relating to locating and paging of other WICs in an environment equipped with fixed access points, as previously described. For example, a patron can use a WIC-enabled kiosk containing a park map to locate other members of the patron's party. In one example, using Bluetooth technology, the location of a WIC can be determined to within 15 feet or less. In addition, a patron can send other party members a page, instructing them to check a message at a kiosk. Of course, with display or Text-To-Speech capabilities, messages can be displayed/played to a user directly. The locating service can also be used to find lost WICs. The locating service can also be used to detect a patron's exit from a park. In another example, the WICs can be used to “tether” a group together. For example, the WICs can be programmed to sound an alert when a member is more than a predetermined distance out of range of the group. The location of WICs can be determined in any desired manner. For example, the techniques described above with respect to FIGS. 5-7 can be used.

In another embodiment, the WICs 202 may include an accelerometer. FIG. 11 is a block diagram a WIC 202 having a transceiver 206, antenna 208, processor 210, and memory 212. The WIC 202 also includes a display 214 and an accelerometer 216. The accelerometer allows tracking of maximum acceleration (g's) and velocity while patrons ride rides. When a user rides a ride, the user can view the maximum number of g's or the maximum velocity experienced. If desired, the WIC 202 can record measurements throughout the day and store them in the memory 212 of the WIC, or transmit the measurements to storage elsewhere. At the end of a day (or throughout the day), a user can get a printout from a kiosk of the measurements on a ride-by-ride basis. This feature also benefits the park operators in several ways. For example, offering users a printout when the leave the park provides an incentive for the users to return the WICs. Also, this feature allows the park to track statistic on ride usage. In addition, the system can detect non-motion (e.g., from injury, etc.) and alert desired people.

The WICs described above may be rented to patrons when they enter a park. Park operators could also provide the WICs as part of the admission price. In another example, a small user fee could be added to each purchase made with the WIC. As described above, the WICs of the present invention provide numerous benefits. For example, a cashless system would reduce theft (both theft from patrons, as well as theft by employees working at a cash register). In addition, the WICs allow a park operator to track patrons and provide statistics on crowds. This benefit allows park operators to check traffic, direct staff where needed, direct crowds to shorter lines, check “out of bounds” crowds, and analyze the use and return on investment of rides.

FIG. 11 also shows a user perceivable device 218 which can be used to alert a user in a number of ways (such as those described above). For example, the alert device 218 may be provided by a vibrator motor, a beeper or buzzer, a status indicator, a speaker, a text-to-speech processor, a CODEC, etc. The user perceivable device 218 gives the WIC 202 numerous additional capabilities. For example, users can send other users pages, voice messages, etc.

As more and more parks and venues are used as areas for social events and mixing, the use of the match function, which matches salient characteristics to user match criteria would be valuable for the park environment as well. Characteristics desired in another user, such as business characteristics in a business mixer, or physical characteristics for a social mixer would be programmed in along with match criteria. As the event proceeds and devices exchange information in an ad-hoc manner as devices come in range for transmission, matches may occur between users and notification of the match and level of match would be provided. Some events, such as an alumni event where alumni from a given graduation year or range of years who participated in football would want to find alumni with similar characteristics, are a refinement of the previous match example. As the range of the devices may certainly provide a match that precludes the line-of-sight visibility to the other user, further exchange of information can be performed as well as the entering the find mode of the device. Likewise, the avoid mode of the device may alert a patron to the presence of a user whose contact would not be desired. For an event such as this, additional display, text-to-speech, or other capability, as previously described, could be added for ease of use.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method for facilitating the exchange of information between wireless devices, comprising:
providing a plurality of wireless devices, each having a transceiver, a processor, and memory;
storing information in each of the memories of the wireless devices relating to characteristics of an actor associated with that wireless device,
automatically establishing a wireless link between a first and a second of the wireless devices;
sending the information stored in the first wireless device to the second wireless device via the wireless link; and
generating a notification at the second wireless device if the sent information meets a predetermined criteria.

2. The wireless device of claim 1, wherein the predetermined criteria includes a predetermined matching of the information sent by the first wireless device and the information stored in the memory of the second wireless device.

3. The wireless device of claim 1, wherein the actor is a person.

4. The wireless device of claim 1, wherein the actor is a machine.

5. The wireless device of claim 1, wherein the wireless link utilizes Bluetooth protocol.

6. The wireless device of claim 1, wherein the notification is an audible sound.

7. The wireless device of claim 6, wherein the sound includes a sampled voice.

8. The wireless device of claim 6, wherein the sound is generated using a text-to-speech processor.

9. The wireless device of claim 1, wherein the storing of the information includes audibly entering words using a speech recognition device.

10. The wireless device of claim 1, wherein the notification is a vibration of the wireless device.

11. The wireless device of claim 1, wherein the notification is an illumination of a light source.

12. The wireless device of claim 1, further comprising:
providing a kiosk; and
sending the information being stored in the memory of one of the wireless devices to the wireless device using the kiosk.

13. A system for facilitating the exchange of information between wireless devices, comprising:
a plurality of wireless devices, each of the wireless devices having:
a transceiver,
a processor,
a memory for storing information relating to characteristics of an actor associated with that wireless device, and
a notification device;
wherein for each of the wireless devices, the processor and transceiver are configured to:
automatically establish a wireless link with another of the plurality of wireless devices,
receive the stored information from the another of the plurality of wireless devices via the wireless link, and
automatically trigger the notification device if the received information meets a predetermined criteria.

14. The system of claim 13, wherein the predetermined criteria includes a predetermined matching of the information received from the another of the plurality of wireless devices and the information stored in the memory of the wireless device.

15. The system of claim 13, wherein the actor is a person.

16. The system of claim 13, wherein the actor is a machine.

17. The system of claim 13, wherein the wireless link utilizes Bluetooth protocol.

18. The system of claim 13, wherein the notification is a device for producing an audible sound.

19. The system of claim 18, wherein the sound includes a sampled voice.

20. The system of claim 18, wherein the notification device includes a text-to-speech processor.

21. The system of claim 13, wherein each of the wireless devices includes a speech recognition input device.

22. The system of claim 13, wherein the notification device is configured to vibrate the wireless device.

23. The system of claim 13, wherein the notification device include a light source to produce light.

24. The system of claim 13, further comprising:
a kiosk having a transceiver for sending information being stored in the various memories of one of the wireless devices to the wireless device using the kiosk.
